(19) United States
(12) Patent Application Publication
(10) Pub. No.: US 2015/0339200 A1
(43) Pub. Date: Nov. 26, 2015

(54) INTELLIGENT DISASTER RECOVERY

(71) Applicant: Cohesity, Inc., San Jose, CA (US)

(72) Inventors: Sashi MADDURI, Mountain View, CA (US); Mohit ARON, Los Altos, CA (US)

(73) Assignee: Cohesity, Inc., San Jose, CA (US)

(21) Appl. No.: 14/283,048

(22) Filed: May 20, 2014

(51) Int. Cl. G06F 11/20

(52) U.S. Cl. CPC G06F 11/2023

(57) ABSTRACT

One embodiment of the invention includes a system for performing intelligent disaster recovery. The system includes a processor and a memory. The memory stores a first monitor application that, when executed on the processor, performs an operation. The operation includes communicating with a second monitor application hosted at a secondary data center to determine an availability of one or more computer servers at a primary data center. The operation also includes upon reaching a consensus with the second monitor application that one or more computer servers at the primary data center are unavailable to process client requests, relative to both the first monitor application and the second monitor application, initiating a failover operation. Embodiments of the invention also include a method and a computer-readable medium for performing intelligent disaster recovery.

### BACKGROUND OF THE INVENTION

1. Field of the Invention

Embodiments presented herein present invention generally relate to computer networking and, more specifically, to intelligent disaster recovery.

2. Description of the Related Art

A wide variety of services are provided over computer networks such as the Internet. Such services are typically implemented based on a client-server model, in which a client requests a server to carry out particular actions (e.g., requests for data, requests for transactions, and the like), and the server executes such actions in response to the requests.

In some instances, faults in software or hardware cause a server providing such services to fail. To protect against such instances, a disaster recovery site may replicate the functionality of servers at the primary site. Should servers at the primary site fail, servers at the secondary site may be activated. The process of activating the disaster recovery site is generally known as “failover,” Typically, when a monitoring system determines that the primary site may have failed, a human administrator is notified and subsequently initiates the failover operation, after verifying that services at the primary site have, in fact, failed for some reason.

Service providers frequently maintain a disaster recover site. However, a when doing so, the disaster recovery site is susceptible to an issue known as the “split brain problem.” The split brain problem occurs when a connection between the primary server site and the disaster recovery site is severed, but both sites are still operating and are each connected to the common computer network (e.g., the Internet). Because the connection between the two sites is severed, each site believes that the other site is not functioning. To avoid “split brain,” issues such as this, the disaster recovery typically notifies a system administrator that the primary site is not functioning (at least from the perspective of the disaster recovery site). The human administrator then investigates the status of each site to determine whether to perform failover.

### SUMMARY OF THE INVENTION

One embodiment of the invention includes a system for performing intelligent disaster recovery. The system includes a processor and a memory. The memory stores a first monitor application that, when executed on the processor, performs an operation. The operation includes communicating with a second monitor application hosted at a secondary data center to determine an availability of one or more computer servers at a primary data center. The operation also includes upon reaching a consensus with the second monitor application that one or more computer servers at the primary data center are unavailable to process client requests, relative to both the first monitor application and the second monitor application, initiating a failover operation. Embodiments of the invention also include a method and a computer-readable medium for performing intelligent disaster recovery.

### BRIEF DESCRIPTION OF THE DRAWINGS

FIG. 1A illustrates a disaster recovery system, according to one embodiment of the present invention;

FIGS. 1B-1F illustrate various scenarios associated with the disaster recovery system of FIG. 1A, according to embodiments of the present invention.

FIG. 2 is a flow diagram of method steps for operating a witness agent within the disaster recovery system of FIG. 1A, according to one embodiment of the present invention;

FIG. 3A illustrates an example primary data center server configured to perform the functionality of the primary data center, according to one embodiment of the present invention;

FIG. 3B illustrates an example secondary data center server configured to perform the functionality of the secondary data center, according to one embodiment of the present invention; and

FIG. 3C illustrates an example consensus server configured to perform the functionality of the witness agent, according to one embodiment of the present invention.

### DETAILED DESCRIPTION OF THE PREFERRED EMBODIMENTS

Embodiments disclosed herein provide an intelligent disaster recovery system. In one embodiment, a witness agent interacts with a primary site and one or more disaster recovery sites. The primary site and disaster recovery sites are each connected to the witness agent over a network. In one embodiment, the witness agent may be software application running on a cloud-based computing host. The witness agent, primary data center, and disaster recovery site each attempt to communicate with one another. The primary data center, the secondary data center, and the witness agent each execute a consensus algorithm to decide whether a failover operation can be automatically performed or whether a system administrator should be notified that the primary data center has become unreachable or unresponsive. In combination, the witness agent and the consensus algorithm reduce the number of false positives that might otherwise be generated.

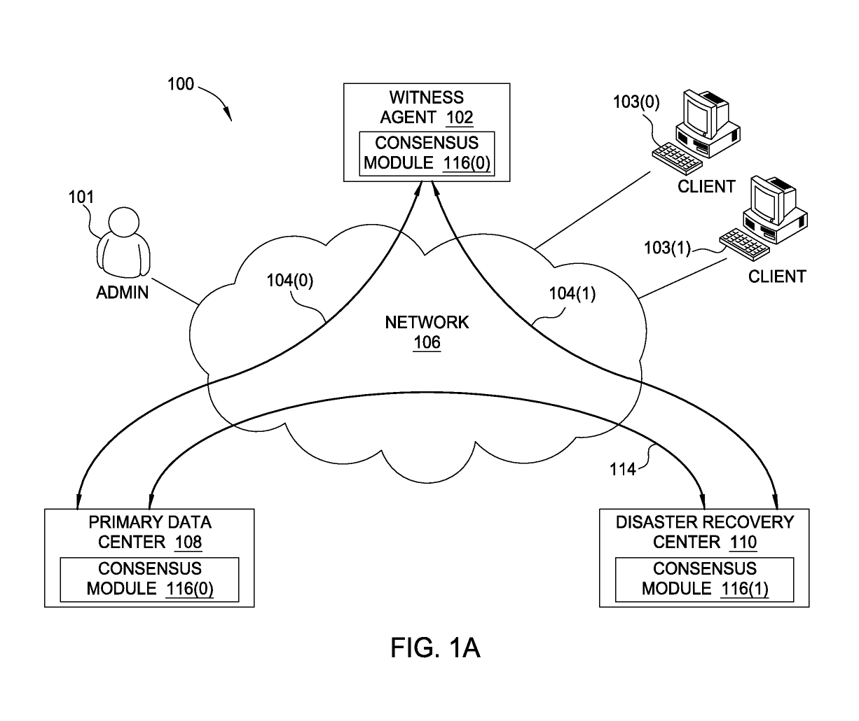

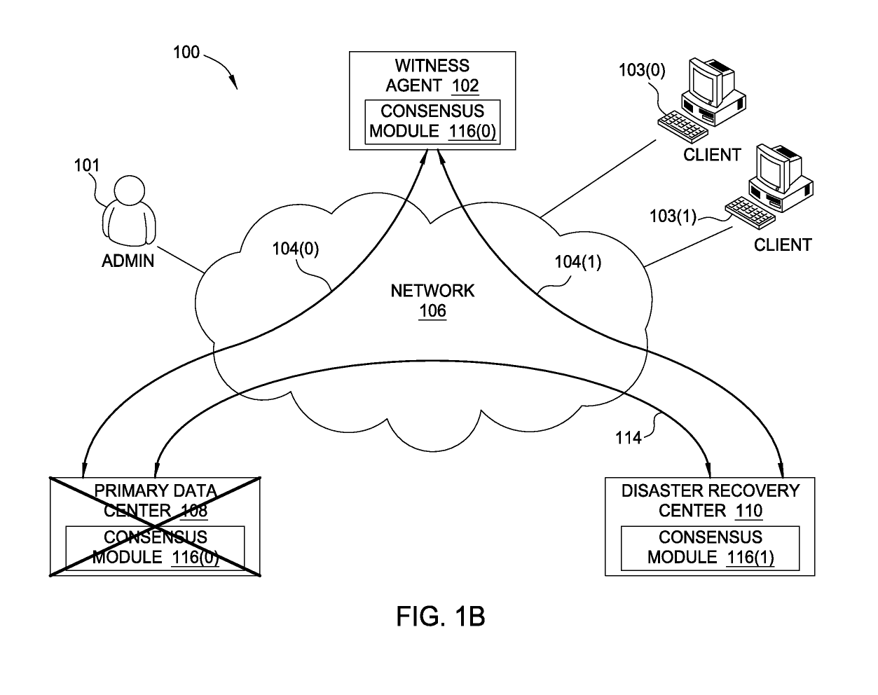

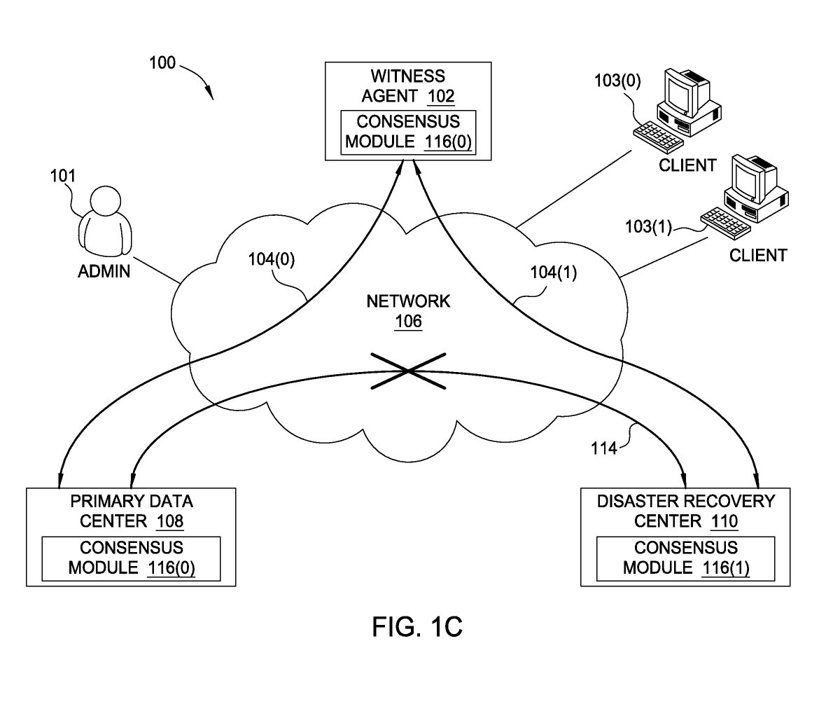

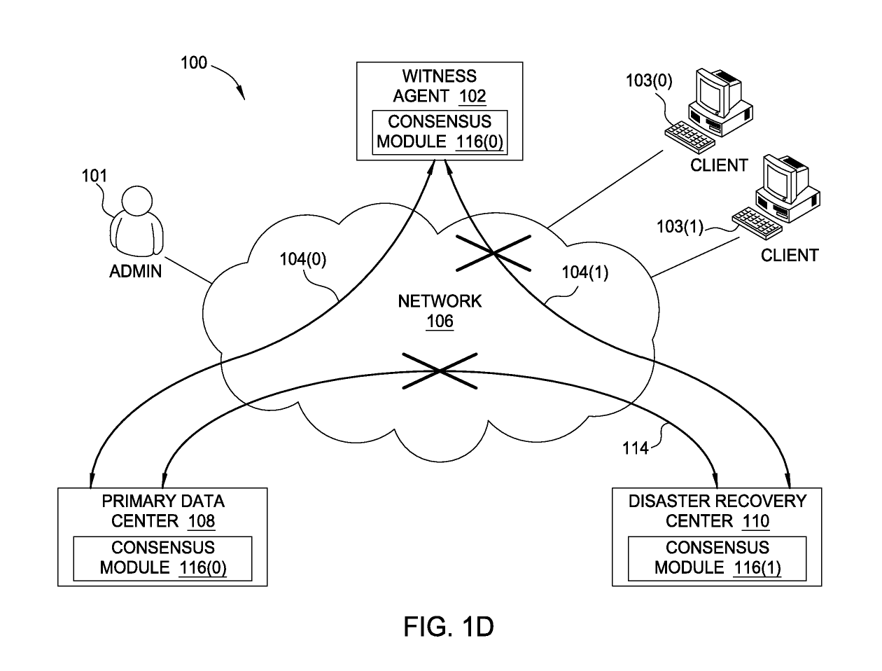

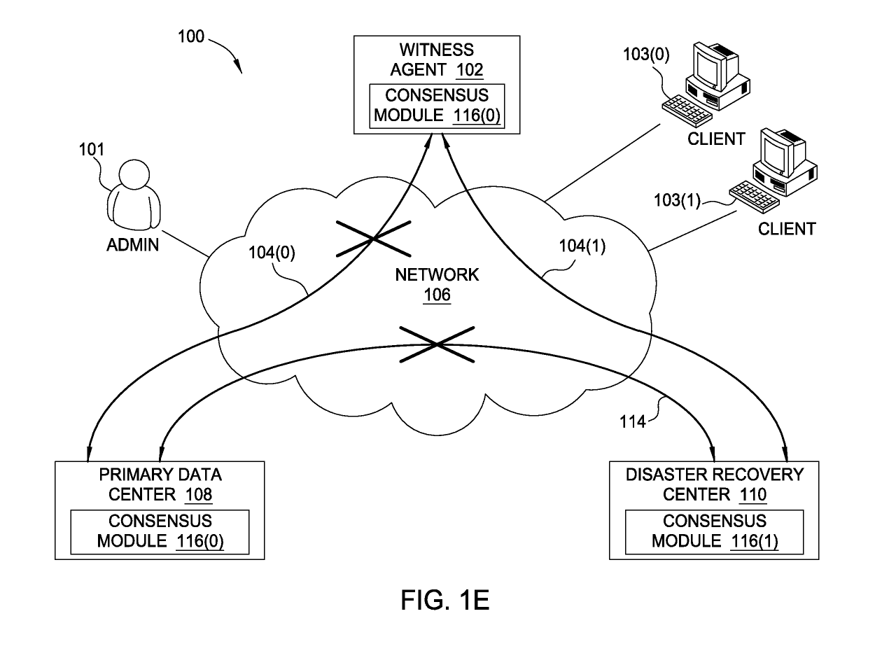

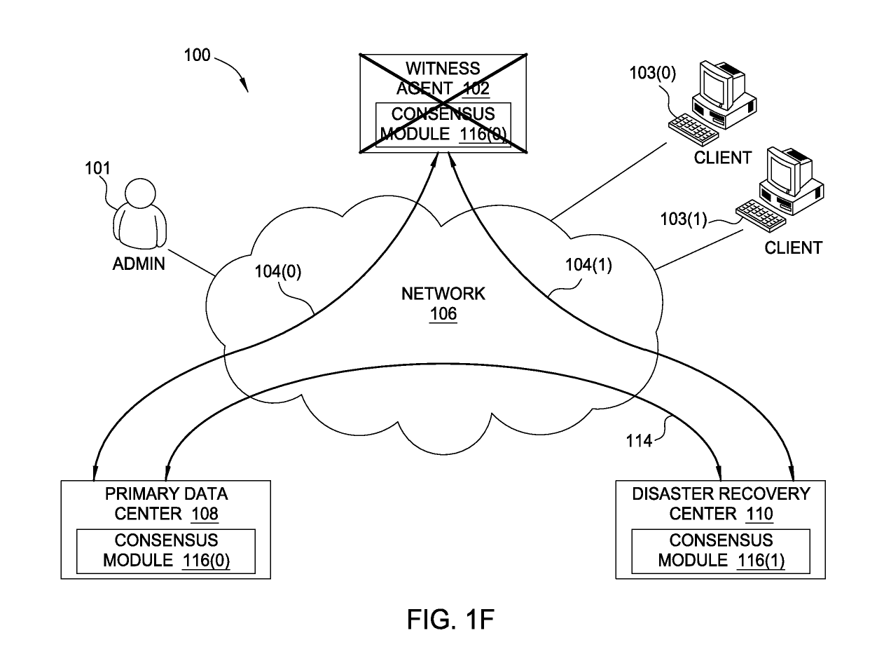

FIG. 1A illustrates a disaster recovery system 100, according to one embodiment of the present invention. As shown, the disaster recovery system 100 includes a primary data center 108, a secondary data center 110, labeled in FIGS. 1A-1F as the disaster recovery data center. The primary data center 108 and secondary data center 110, along with a witness agent 102, are each connected to a network 106. Clients 103 and an administrator 101 are also connected to the network 106.

Clients 103 send requests to the primary data center 108. Examples of such requests include requests for information, requests to modify a database, and the like. More generally, clients 103 may access primary data center 108 to request any form of computing service or transaction. When functioning, the primary data center 108 responds to those requests and performs corresponding actions. If the primary data center 108 is not fully functional, then the primary data center 108 may not respond to requests from clients 103 and considered unreachable or unresponsive. The terms “unreachable” and “unresponsive” generally refer to situations where primary data center 108 is believed to be unable to respond to requests received via network 106.

In one embodiment, secondary data center 110 monitors the primary data center 108 by sending messages 114 over network 106. When the primary data center 108 is unreachable or unresponsive, the secondary data center 110 can accept and process requests from clients 103 intended for the primary data center 108. The process of switching from the primary data center 108 processing requests to the secondary data center 110 processing requests is referred to herein as a “failover operation.” In some embodiments, a failover operation is triggered by administrator 101 after learning that the primary data center 108 is unreachable or unresponsive. In an alternative embodiment, the secondary data center 110 may execute a failover operation without requiring action by the administrator 101 (i.e., in an automated manner).

In some cases, the primary data center 108 does not actually become unreachable or unresponsive, but instead, the communication channel 114 between the primary data center 108 and the secondary data center 110 is severed. In these cases, the secondary data center 110 is unable to communicate with the primary data center 108 and is unable to determine whether the primary data center 108 is unreachable or unresponsive via communication channel 114.

Without the witness agent 102, the secondary data center 110 would have to notify the administrator 101 that the secondary data center 110 is unable to determine whether the primary data center 108 is unresponsive and requests instructions. The administrator would investigate the primary data center 108 to determine the status of the primary data center 108. In the situation in which communication channel 114 is severed, the administrator would determine that the primary data center 108 is not unreachable or unresponsive. In this case, the administrator 101 has received a “false positive” notification that the primary data center 108 is down.

This false positive results from what is known as a “split brain scenario.” In FIG. 1A, a split brain scenario would occur without the witness agent 102 because when the communication link 114 is severed, neither the primary data center 108 nor the secondary data center 110 can determine the status of the other site. Thus, both cites may inform the administrator 101 to allow the administrator 101 to respond to the situation.

To assist the primary data center 108 and the secondary data center 110 to determine whether to activate the secondary data center 110, the disaster recovery system 100 includes a witness agent 102. In one embodiment, the witness agent 102 communicates with both the primary data center 108 and the secondary data center 110. As described in greater detail below, the witness agent 102 (and corresponding consensus modules 116) allow the primary data center 108 and the secondary data center 110 to each determine the availability of the primary data center 108 in a consistent manner (i.e., whether to consider the primary data center 108 as having failed).

Each node (where the word “node” generally refers to one of the primary data center 108, secondary data center 110, and witness agent 102) executes a consensus algorithm based on the information available to that node about the status of the other nodes, to determine the status of the primary data center in a consistent manner. As shown, consensus module 116 within each node executes the consensus algorithm. The consensus module 116 generally corresponds to one or more software applications executed by each node.

Witness agent 102 communicates with primary data center 108 over communication link 104(0) and with secondary data center 110 over communication link 104(1). The witness agent 102 is preferably located in a physically separate location from both the primary data center 108 and the secondary data center 110, so that faults resulting from events such as natural disasters that affect one of the other nodes do not affect the witness agent 102. For example, in one embodiment, the witness agent 102 may be hosted by a cloud-based service, meaning that witness agent 102 is hosted by a computer service hosted by one or more cloud service providers that can provide computing resources (e.g., a virtual computing instance and network connectivity) to host the software applications providing witness agent 102.

The primary data center 108, the secondary data center 110, and the witness agent 102 each attempt to communicate with one another. Note, the primary data center 108, the secondary data center 110, and the witness agent 102 are generally referred to as a “node.” In one embodiment, the primary data center 108 attempts to communicate with secondary data center 110 via communication link 114 and with witness agent 302 via communication link 104(0). Secondary data center 110 attempts to communicate with primary data center 308 via communication link 114 and with witness agent via link 104(1). Witness agent 102 attempts to communicate with primary data center 108 via communication link 104(0) and with secondary data center 110 via communication link 104(1). If a first node is unable to communicate with a second node, then the first node considers the second node to be unreachable or unresponsive.

The secondary data center 110 periodically attempts to communicate with the primary data center 108 and the witness agent 102 in order to determine a state of the primary data center 108. If the secondary data center 110 is able to communicate with the primary data center 108, then the secondary data center 110 reaches a consensus that the primary data center 108 is online. If the secondary data center 110 is unable to communicate with the primary data center 108, then the secondary data center 110 attempts to reach a consensus with the witness agent 102 regarding the state of the primary data center 108. If the witness agent 102 is unable to communicate with the primary data center 108, then the secondary data center 110 reaches consensus with the witness agent 102 that the primary data center 108 is unreachable or unresponsive. If the witness agent 102 is able to communicate with the primary data center 108, then the secondary data center 110 does not reach a consensus that the primary data center 108 is unreachable or unresponsive.

The primary data center 108 operates normally (i.e., serves client 103 requests) unless the primary data center 108 cannot reach consensus regarding the status of the primary data center 108 with at least one other node. In other words, if the primary data center 108 cannot communicate with either the secondary data center 110 or the witness agent 102, then the primary data center 108 determines it is “down”. Note, in doing so, each of the primary data center 108, witness agent 102, and secondary data center 110 reach a consistent conclusion regarding the state of the primary data center 108, and can consistently determine whether the secondary data center 110 can be activated, avoiding a split-brain scenario.

Secondary data center 110 performs a failover operation if the secondary data center 110 determines, in conjunction with the witness agent 102, that the primary data center 108 should be deemed unreachable or unresponsive. If the secondary data center 110 is unable to reach such a consensus, then secondary data center 110 does not perform a failover operation. In some embodiments, secondary data center 110 performs a failover operation automatically when the secondary data center 110 reaches a consensus with the monitor 102 that the primary data center 108 is unreachable or unresponsive. In other embodiments, the secondary data center 110 may notify the administrator 101. The term “failover operation,” refers to both an automatic failover operation and operation of notifying an administrator 101 that a failover operation may be needed.

In one embodiment, the consensus algorithm performed by the primary, secondary, and cloud monitor is modeled on the Paxos algorithm. Paxos provides a family of protocols for reaching consensus in a network of nodes. A typical use of the Paxos family of protocols is for leader election (referred to herein as “Paxos for leader election”). In such a usage, each node may attempt to become a leader by declaring itself a leader and receiving approval by consensus (or not) from the other nodes in the system. In other words, one node attempts to become leader by transmitting a request to become leader to the other nodes. The requesting node becomes leader if a majority of nodes reach consensus that the requesting node should be leader.

In one embodiment, the primary data center 108 has preferential treatment for being elected the “leader.” The secondary data center 110 does not attempt to become the leader as long as the secondary data center 110 is able to communicate with the primary data center 108. The witness agent 102 does not allow the secondary data center 110 to become the leader as long as the witness agent 102 is able to communicate with the primary data center 108. Thus, the secondary data center 110 is able to become leader only if both the secondary data center 110 and the witness agent 102 are unable to communicate with the primary data center 108. The witness agent 102 acts as a “witness.” In the present context, a “witness” is a participant in the consensus process that does not attempt to become the leader but is able to assist the other nodes in reaching consensus.

In this case, the node which becomes the leader (whether the primary data center 108 or the secondary data center 110) is the node that services client 103 requests. Thus, when the primary data center 108 is the leader, the primary data center services client 103 requests and when the secondary data center 110 is the leader, the secondary data center 110 services client 103 requests.

In one embodiment, the primary data center 108 periodically asserts leadership (attempts to “renew a lease”) between itself and other nodes. The primary data center 108 becomes (or remains) leader if a majority of the nodes agree to elect the primary data center 108 as leader (i.e., the nodes have reached a consensus allowing the primary data center 108 to become leader). Because the primary data center 108 has preferential treatment as the leader, if the primary data center 108 is able to contact any other node, the primary data center 108 becomes leader or retains leadership. If the primary data center 108 is unable to contact any other node, then the primary data center 108 is unable to gain or retain leadership and thus does not serve requests from clients 103. A primary data center 108 that has leadership may lose leadership after expiration of the lease that grants the primary data center 108 leadership. If the primary data center 108 can no longer contact the secondary data center 110 and the witness agent 102, then the primary data center 108 does not regain leadership (at least until the primary data center 108 is again able to communicate with either the secondary data center 110 or the witness agent 102).

If the secondary data center 110 is unable to contact the primary data center 108, then the secondary data center 110 attempts to be elected leader by communicating with the witness agent 102. If the witness agent 102 is also unable to contact the primary data center 108, then the witness agent 102 agrees with the secondary data center 110 that the secondary data center 110 should become the leader. By becoming leader, the secondary data center 110 has reached a consensus with the witness agent 102 that the primary data center 108 is not functioning and initiates a failover operation.

The operations described above contemplate that a consensus is reached when two of the three nodes—a majority—agree on a particular matter. In some embodiments, the disaster recovery system 100 includes more than three nodes. In such embodiments, a consensus is reached when a majority agrees on a particular matter.

If no communications links are severed, and each node is properly functioning, as is the case in FIG. 1A, then each node reaches the same consensus about each other node. If, however, one or more communications links have been severed or one of the nodes is not functioning, then at least one node is unable to reach consensus, assuming that node is functioning at all. FIGS. 1B-1F illustrate scenarios where communications links are severed or the primary data center 108, or secondary data center 110, or witness agent 102 are not functioning.

FIG. 1B illustrates an example where primary data center 108 has malfunctioned. When this occurs the secondary data center 110 and the witness agent 102, being unable to communicate with the primary data center 108, each determine that the primary data center 108 is unreachable or unresponsive. Because two out of three nodes believe that the status of the primary data center 108 is unreachable or unresponsive, both nodes can reach a consensus regarding that status. In this example, the secondary data center 110 initiates a failover operation after reaching consensus with the monitor 102 that primary data center 108 has failed (or become otherwise unreachable). In the implementation of the consensus algorithm that is based on Paxos, the secondary data center 110 gains leadership because neither the secondary data center 110 nor the witness agent 102 is able to communicate with the primary data center 108.

FIG. 1C illustrates an example of the disaster recovery system 100 where the communication link 114 between the primary data center 108 and the secondary data center 110 is severed, but in which each of the three nodes is functioning. In this situation, the primary data center 108 and the secondary data center 110 cannot communicate with each other. However, the witness agent 102 is able to communicate with both the witness agent 102 and the secondary data center 110. Therefore, the secondary data center 110 cannot reach a consensus with the witness agent 102 that the primary data center 108 is unreachable or unresponsive. Because the secondary data center 110 does not reach a consensus that the primary data center 108 is unreachable or unresponsive, the secondary data center 110 does not initiate a failover operation.

When the communication link 114 is severed, but the primary data center 108 is still operational, the secondary data center 110 does not conclude, using the common consensus protocol, that the primary data center 108 is unreachable or unresponsive. This occurs due to the presence of the witness agent 102. Thus, the witness agent 102 reduces false positive notifications to the administrator 101 that the primary data center 108 has become unreachable or unresponsive. In the implementation of the consensus algorithm that is based on Paxos, the secondary data center 110 does not gain leadership the witness agent 102 is able to communicate with the primary data center 108 and thus does not allow the secondary data center 110 to become leader.

FIG. 1D illustrates an example of the disaster recovery system 100 of FIG. 1A where both communication link 114 between the primary data center 108 and the secondary data center 110 and communication link 104(1) between the witness agent 102 and the secondary data center 110 are severed. However, each of the three nodes remains functional, As with the example illustrated in FIG. 1C, the primary data center 108 and witness agent 102 reach consensus that the primary data center 108 is functioning. At the same time the secondary data center 110 does not reach a consensus with the witness agent 102 that the primary data center 108 is not functioning and thus does not initiate a failover. Note, the system administrator could, of course, be notified that the primary site is unreachable or unresponsive, at least from the perspective of the secondary data center. In the implementation of the consensus algorithm that is based on Paxos, the primary data center 108 retains leadership because the primary data center 108 is able to communicate with the witness agent 102.

FIG. 1E illustrates the disaster recovery system 100 of FIG. 1A, in which both the communication link 114 between the primary data center 108 and the secondary data center 110 and the communication link 104(0) between the witness agent 102 and the primary data center 108 are severed, but in which each of the three nodes is functioning. In this scenario, the primary data center 108 is unable to reach consensus regarding the status of the witness agent 102 or the secondary data center 110 and therefore does not operate normally (i.e., does not serve requests from clients). Because the witness agent 102 and the secondary data center 110 cannot communicate with the primary data center 108, both reach a consensus that the primary data center 108 is unreachable or unresponsive. Because of this consensus, the secondary data center 110 initiates a failover operation. in the implementation of the consensus algorithm that is based on Paxos, the secondary data center 110 gains leadership because neither the secondary data center 110 nor the witness agent 102 is able to communicate with the primary data center 108.

FIG. 1F illustrates the disaster recovery system 100 of FIG. 1A, in which the witness agent 102 is not functioning, but in which the other two nodes are functioning. In this scenario, both the primary data center 108 and the secondary data center 110 are able to reach consensus that both the primary data center 108 and the secondary data center 110 are operational. Therefore, the secondary data center 110 does not initiate a failover operation. In the example consensus protocol that is based on Paxos, the primary data center 108 is able to obtain leadership from the secondary data center 110. Therefore, the secondary data center 110 does not initiate a failover operation.

In one additional example situation, the secondary data center is unreachable or unresponsive. In this situation, the primary data center 108 and the witness agent 102 reach consensus that the secondary data center 110 is unreachable or unresponsive. The secondary data center 110 does not initiate a failover operation even if the secondary data center 110 is operating normally because the secondary data center 110 cannot reach consensus with any other node, as no other node is able to communicate with the secondary data center 110.

In the example consensus protocol that is based on Paxos, the primary data center 108 is able to obtain leadership and the secondary data center 110 is not able to obtain leadership. Thus, the disaster recovery system 100 operates normally. In an additional example situation, each of the communication links (link 114, link 104(0), and link 104(1)) are severed. In this situation, no node is able to reach consensus on the status of any other node. Because the secondary data center 110 does not reach any consensus, the secondary data center 110 does not initiate a failover operation. In the Paxos-based consensus algorithm, the secondary data center 110 is unable to obtain leadership and thus does not initiate a failover operation.

If the disaster recovery system 100 is operating in a failover mode (the secondary data center 110 has initiated a failover operation and is now serving client 103 requests instead of the primary data center 108), subsequent changes in condition to the primary data center 108 or to the communications links (link 114, link 104(0), and/or link 104(1)) may cause the secondary data center 110 to execute a failback operation. A tailback operation causes the primary data center 108 to again serve requests from clients 103 and causes secondary data center 110 to cease serving requests from clients 103. Secondary data center 110 may also transfer data generated and/or received during servicing client 103 requests to the primary data center 108 to update primary data center 108.

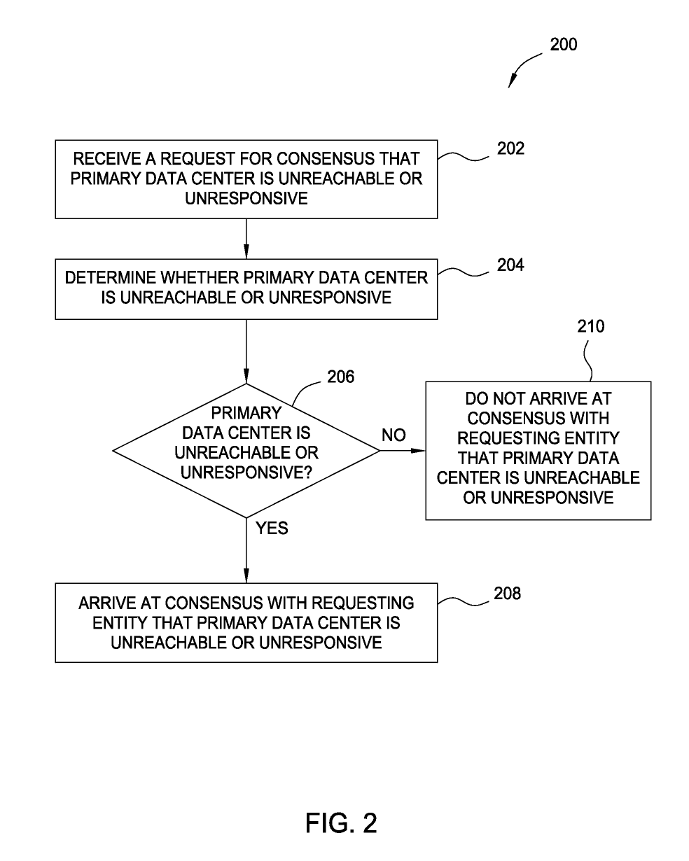

FIG. 2 is a flow diagram of method steps for operating a witness agent within the disaster recovery system of FIG. 1A, according to one embodiment of the present invention. Although the method steps are described in conjunction with FIGS. 1A-1F, persons skilled in the art will understand that any system configured to perform the method steps, in any order, falls within the scope of the present invention.

As shown, method 200 begins at step 202, where witness agent 102 receives a request for consensus from either or both of a primary data center 108 and a secondary data center 110 regarding the functionality of the primary data center 108. In step 204, the witness agent 102 determines whether the primary data center 108 is unreachable or unresponsive.

In step 206, if the witness agent 102 determines that the primary data center 108 is unreachable or unresponsive, then at step 208, which the witness agent 102 arrives at a consensus with the secondary data center 110 that the primary data center 108 is unreachable or unresponsive. In step 206, if the witness agent 102 determines that the primary data center 108 is not unreachable or unresponsive, then at step 210 the witness agent 102 does not arrive at consensus with the secondary data center 110 that the primary data center 108 is unreachable or unresponsive.

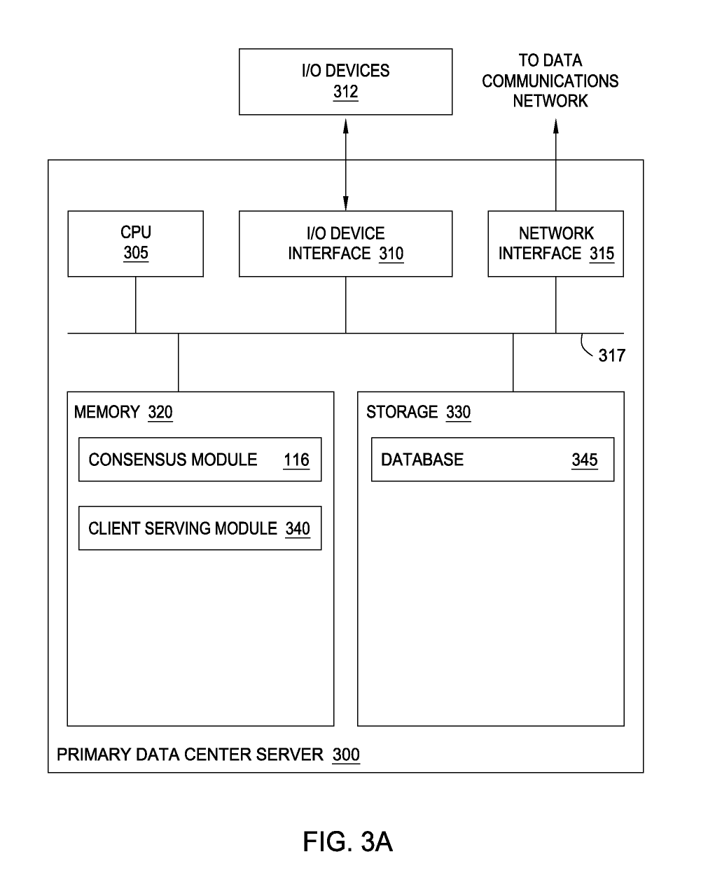

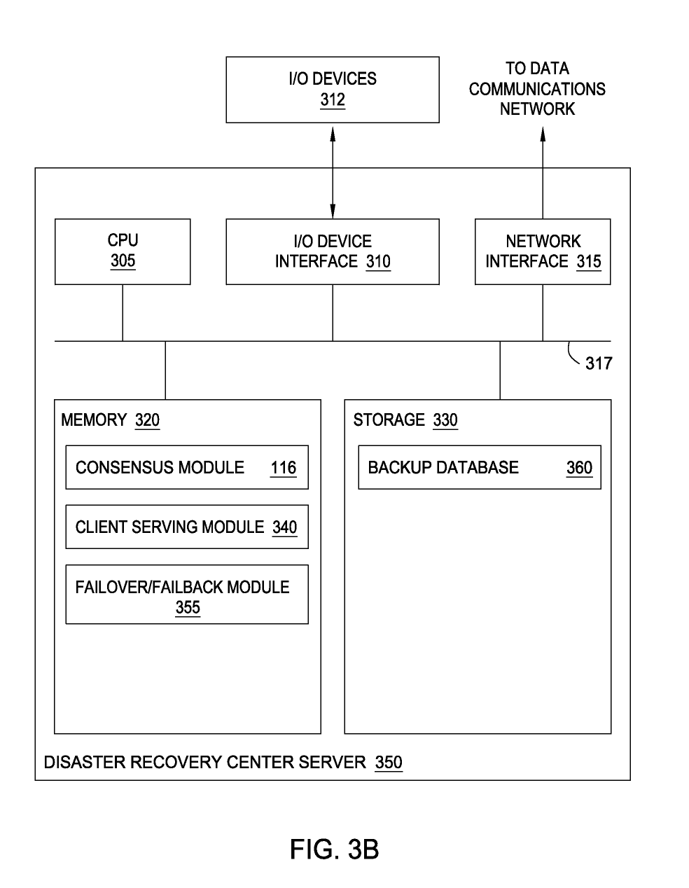

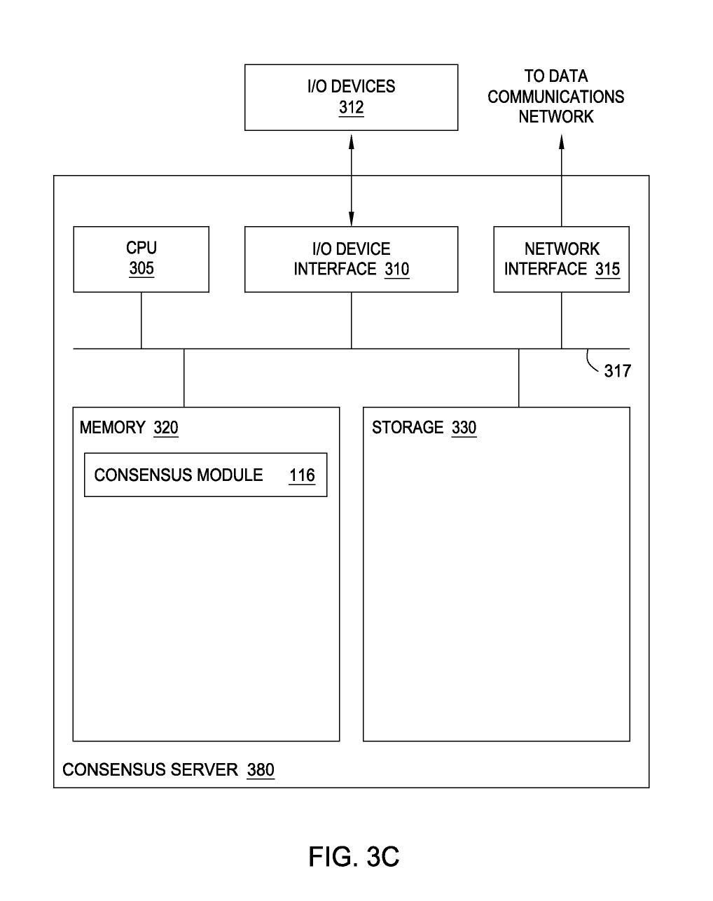

FIG. 3A illustrates an example server 300 configured to perform the functionality of the primary data center 108, according to one embodiment of the present invention. As shown, the server 300 includes, without limitation, a central processing unit (CPU) 305, a network interface 315, a memory 320, and storage 330, each connected to a bus 317. The computing system 300 may also include an I/O device interface 310 connecting I/O devices 312 (e.g., keyboard, display and mouse devices) to the computing system 300. Further, in context of this disclosure, the computing elements shown in computing system 300 may correspond to a physical computing system (e.g., a system in a data center) or may be a virtual computing instance executing within a computing cloud.

The CPU 305 retrieves and executes programming instructions stored in the memory 320 as well as stores and retrieves application data residing in the storage 330. The interconnect 317 is used to transmit programming instructions and application data between the CPU 305, I/O devices interface 310, storage 330, network interface 315, and memory 320. Note that CPU 305 is included to be representative of a single CPU, multiple CPUs, a single CPU having multiple processing cores, and the like. And the memory 320 is generally included to be representative of a random access memory. The storage 330 may be a disk drive storage device. Although shown as a single unit, the storage 330 may be a combination of fixed and/or removable storage devices, such as fixed disc drives, removable memory cards, optical storage, network attached storage (NAS), or a storage area-network (SAN).

Illustratively, the memory 320 includes consensus module 116 and client serving module 340. Storage 330 includes database 345. The consensus module 116 attempts to reach consensus with the nodes in the disaster recovery system 100 regarding the state of the primary data center 108 or the secondary data center 110. The client serving module 340 interacts with clients 103 through network interface 315 to serve client requests and read and write resulting data into database 345.

FIG. 3B illustrates an example secondary data center server 350 configured to perform the functionality of the secondary data center 110, according to one embodiment of the present invention. As shown, the secondary data center server 350 includes many of the same elements as are included in the primary data center server 300, including I/O devices 312, CPU 305, I/O device interface 310, network interface 315, bus 317, memory 320, and storage 330, each of which functions similarly to the corresponding elements described above with respect to FIG. 3A. The memory 320 includes a consensus module 116, client serving module 340, and failover/failback module 355. The storage 330 includes a backup database 360.

When primary data center 108 serves requests 103, secondary data center 110 does not. During this time, secondary data center server 350 maintains the backup database 360 as a mirror of the database 345. Failover/failback module 355 performs failover and failback operations when secondary data center 110 serves client requests, as described above. Client serving module 340 serves client 103 requests when secondary data center 110 is activated following a confirmed failure of the primary data center 108, for example, when the secondary data center 110 reaches consensus with the witness agent 102.

FIG. 3C illustrates an example consensus server 380 configured to perform the functionality of the witness agent 102, according to one embodiment of the present invention. As shown, the consensus server 380 includes many of the same elements as are included in the primary data center server 300, including I/O devices 312, CPU 305, I/O device interface 310, network interface 315, bus 317, memory 320, and storage 330, each of which functions similarly to the corresponding elements described above with respect to FIG. 3A. The memory 320 includes a consensus module 116, which performs the functions of witness agent 102 described above. As noted, the consensus server 380 may be a virtual computing instance executing within a computing cloud.

One advantage of the disclosed approach is that including a witness agent in a disaster recovery system reduces the occurrence of false positive failover notifications transmitted to an administrator. Reducing false positive notifications in this manner reduces the unnecessarily utilization of administrator resources, which improves efficiency. Another advantage is that the failover/failback process may be automated. Thus, an administrator 101 does not need to be notified in order to initiate a failover operation or failback operation.

One embodiment of the invention may be implemented as a program product for use with a computer system. The program(s) of the program product define functions of the embodiments (including the methods described herein) and can be contained on a variety of computer-readable storage media. Illustrative computer-readable storage media include., but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended dams. The foregoing description and drawings are, accordingly, to be regarded in an illustrative rather than a restrictive sense.

What is claimed is:

1. A system comprising:
a processor; and
a memory storing a first monitor application, which, when executed on the processor performs an operation, comprising:
communicating with a second monitor application hosted at a secondary data center to determine an availability of one or more computer servers at a primary data center, and
upon reaching a consensus with the second monitor application that one or more computer servers at the primary data center are unavailable to process client requests, relative to both the first monitor application and the second monitor application, initiating a failover operation.

2. The system of claim 1, wherein the first monitor application and the second monitor application reach consensus that the primary data center is unavailable when both the first monitor application and the second monitor application are unable to communicate with the primary data center.

3. The system of claim 1, wherein communicating with the second monitor application comprises receiving a request from the second monitor application to reach consensus regarding the availability of the one or more computer servers at the primary data center.

4. The system of claim 3, wherein the first monitor application declines to reach the consensus when the first monitor application is able to communicate with the primary data center.

5. The system of claim 3, wherein the secondary data center generates the request after an attempt by the second monitor application to communicate with the primary data center has failed.

6. The system of claim 1, wherein the failover operation is configured to cause one or more servers at the secondary data center to begin processing requests from clients.

7. The system of claim 1, wherein the failover operation comprises notifying a system administrator that the first monitor application and the second monitor application have reached consensus that one or more servers at the primary data center are unavailable to process requests from clients.

8. The system of claim 1, wherein the primary data center includes a third monitor application configured to communicate with the first monitor application and the second monitor application, and wherein the first monitor application and the second monitor application reach consensus that the one or more computer servers at the primary data center are unavailable to process client requests when both are unable to communicate with the third monitor application.

9. The system of claim 1, wherein the first monitor application is hosted on a computer server at a location distinct from the primary data center and the secondary data center.

10. A method comprising:
communicating with a second monitor application hosted at a secondary data center to determine an availability of one or more computer servers at a primary data center, and
upon reaching a consensus with the second monitor application that one or more computer servers at the primary data center are unavailable to process client requests, relative to both a first monitor application and the second monitor application, initiating a failover operation.

11. The method of claim 10, wherein consensus is reached with the second monitor application that the primary data center is unavailable when both the first monitor application and the second monitor application are unable to communicate with the primary data center.

12. The method of claim 10, wherein communicating with the second monitor application comprises receiving a request from the second monitor application to reach consensus regarding the availability of the one or more computer servers at the primary data center.

13. The method of claim 12, further comprising declining to reach the consensus when the first monitor application is able to communicate with the primary data center.

14. The method of claim 12, wherein the secondary data center generates the request after an attempt by the second monitor application to communicate with the primary data center has failed.

15. The method of claim 10, further comprising causing one or more servers at the secondary data center to begin processing requests from clients.

16. The method of claim 10, further comprising notifying a system administrator that the first monitor application and the second monitor application have reached consensus that one or more servers at the primary data center are unavailable to process requests from clients.

17. A non-transitory computer-readable medium storing instructions that, when executed by a processor, cause the processor to perform the steps of:
communicating with a second monitor application hosted at a secondary data center to determine an availability of one or more computer servers at a primary data center, and
upon reaching a consensus with the second monitor application that one or more computer servers at the primary data center are unavailable to process client requests, relative to both a first monitor application and the second monitor application, initiating a failover operation.

18. The non-transitory computer-readable medium of claim 17, wherein consensus is reached with the second monitor application that the primary data center is unavailable when both the first monitor application and the second monitor application are unable to communicate with the primary data center.

18. The non-transitory computer-readable medium of claim 17, wherein communicating with the second monitor application comprises receiving a request from the second monitor application to reach consensus regarding the availability of the one or more computer servers at the primary data center.

19. The non-transitory computer-readable medium of claim 18, further storing instructions that, when executed by the processor, cause the processor to execute the step of declining to reach the consensus when the first monitor application is able to communicate with the primary data center.

20. The non-transitory computer-readable medium of claim 17, further storing instructions that cause the processor to execute the step of causing one or more servers at the secondary data center to process requests from clients.
